(19) United States
(12) Patent Application Publication
(10) Pub. No.: US 2007/0007105 A1
(43) Pub. Date: Jan. 11, 2007

(54) Coin metal-processing device and method of controlling the device

(76) Inventors: Eiji Itako, Saitama (JP); Tsunehiro Aso, Saitama (JP)

Correspondence Address: FISH & RICHARDSON P.C., P.O. BOX 1022, MINNEAPOLIS, MN, 55440-1022, US

(21) Appl. No.: 10/558,104

(22) PCT Filed: May 20, 2004
(86) PCT No.: PCT/JP04/06836

§ 371 Date: Nov. 21, 2005

(30) Foreign Application Priority Data
May 22, 2003 (JP) 2003145422
Feb. 12, 2004 (JP) 2004035185

(51) Int. Cl. G07D 5/08

(52) U.S. Cl. 194/319

(57) ABSTRACT

A coin metal processing device and a method of controlling the device, where whether or not a metal-coin is acceptable and value information etc. for the metal-coin can be set, and where both ordinary coins and metal-coins cam be used. A setting portion (5) is operated to shift a coin metal processing device (1) to a metal-coin setting mode, coins with the value equivalent to a set value are dropped in, and the value of coins identified is memorized in a memory (9). A predetermined number of coins are collected at any time by a characteristics data collecting portion (6) and stored in a characteristics data-storing portion (7). A characteristics data analyzing portion (8) analyzes whether or not the characteristics data overlap with characteristics data of each coin and further analyzes whether or not variations of the characteristics data are within a specified value. A control portion (2) sets reception of the metal-coins based on the result of the analysis. When the reception of the metal-coins is permitted, the value memorized in the memory is set as a set value.

### TECHNICAL FIELD

The present invention relates to a coin metal processing device and a method of controlling the coin metal processing device and, more particularly, to a coin metal processing device and a method of controlling the coin metal processing device for performing promotions of giving away specified products and so forth by using coin-like metal pieces in addition to ordinary coins.

### BACKGROUND ART

Currently, the demand for performing promotions such as giving away specified products by enabling a coin processing device, which is incorporated in automatic vending machines, exchange machines and game devices, to receive a coin metal (referred to as ‘metal-coin’ hereinafter) in addition to an ordinary coin has come from a variety of industries.

In order to meet this demand, there are coin processing devices in which characteristic data for identifying metal-coins is additionally written to, for example, an internal memory that stores characteristic data for identifying ordinary coins so that the coin processing devices can receive metal-coins by identifying metal-coins on the basis of the characteristic data for the metal-coins, whereby these coin processing devices are able to receive both ordinary coins and metal-coins (See Patent document 1, for example).

However, in the current state, short-term development is required in several lots for each metal-coin and there is also a need to take charge of 100 or more metal-coins and so forth as production commodities in production technology or a line. Therefore, management costs are also incurred and, unlike the coins in circulation, there are problems in security.

Further, there is also a problem that confirmation and assurance for mistakes during metal-coin reception cannot be performed suitably due to the existence of metal-coins of varied shapes, thickness, and quality.

Patent document 1: Japanese Patent Application Publication No. 07-105424

### DISCLOSURE OF THE INVENTION

Therefore, the present invention solves the above problems and an object of the present invention is to provide a coin metal processing device and a method of controlling the metal processing device, capable of easily setting whether the reception of metal-coins is acceptable or unacceptable, and value information and so forth for the metal-coins, and capable of using both ordinary coins and metal-coins.

In order to achieve the above object, the invention in claim 1 is a coin metal processing device which is incorporated in an automatic vending machine and performs desired processing by receiving coins and coin-like metal pieces that are inserted into the coin metal processing device, comprising metal setting means for shifting the coin metal processing device to a mode that performs setting to permit reception of the coin-like metal pieces; characteristic detecting means for detecting respective characteristics of a predetermined number of coin-like metal pieces inserted continuously after the metal setting means is operated; characteristic collecting means for collecting the characteristics of the coin-like metal pieces detected by the characteristic detecting means; metal piece reception setting means for performing setting so that the coin-like metal pieces can be received in cases where the characteristics of the coin-like metal pieces collected by the characteristic collecting means do not overlap characteristics of receivable coins and variations in the characteristics of the coin-like metal pieces collected by the characteristic collecting means are within specified values; and deposit signal generating means for generating a predetermined deposit signal when a coin-like metal piece that is set as receivable by the metal reception setting means is received.

The metal setting means correspond with the setting portion 5 shown in FIG. 1.

Further, the invention of claim 2 is the coin metal processing device according to claim 1, wherein the metal setting means is provided in correspondence with a type of a receivable coin, and the deposit signal generating means generates a deposit signal of a type that corresponds with the operated metal setting means.

Further, the invention of claim 3 is the coin metal processing device according to claim 2, wherein the metal setting means is a reception accuracy switching switch that is provided in correspondence with the type of a receivable coin.

In addition, the invention of claim 4 is the coin metal processing device according to claim 1, further comprising: value information storing means for storing and holding value information for at least one inserted coin, wherein the deposit signal generating means generates a deposit signal that corresponds with value information stored and held by the value information storing means.

Furthermore, the invention of claim 5 is the coin metal processing device according to claim 4, wherein the metal setting means is operated after a coin of a predetermined value is inserted; the deposit signal generating means generates a deposit signal that corresponds with value information on the coin of the predetermined value inserted before the metal setting means is operated.

Further, the invention of claim 6 is the coin metal processing device according to claim 4, wherein the metal setting means is operated before a coin of a predetermined value is inserted; the deposit signal generating means generates a deposit signal that corresponds with value information on the coin of the predetermined value that is inserted after the metal setting means is operated.

In addition, the invention of claim 7 is the coin metal processing device according to claim 4, wherein the metal reception setting means performs setting to enable the reception of one coin-like metal piece at the time of one sales operation.

Further, the invention of claim 8 is the coin metal processing device according to claim 4, wherein the metal reception setting means performs settings to enable the reception of a plurality of coin-like metal pieces at the time of one sales operation.

In addition, the invention of claim 9 is the coin metal processing device according to claim 1, further comprising: metal reception setting canceling means for canceling the state where coin-like metal pieces can be received, which is set by the metal reception setting means.

Furthermore, the invention of claim 10 is the coin metal processing device according to claim 9, wherein the metal reception setting canceling means cancels the state where coin-like metal pieces can be received, which is set by the metal reception setting means, upon detecting the fact that a return lever has been operated for a predetermined time within a predetermined time after the metal setting means is operated.

Further, the invention of claim 11 is a method of controlling a coin metal processing device which is incorporated in an automatic vending machine and which performs desired processing by receiving coins and coin-like metal pieces that are inserted into the coin metal processing device, characterized by comprising the steps of detecting the respective characteristics of a predetermined number of coin-like metal pieces that are inserted continuously after the metal setting means, which shifts the coin metal processing device to a mode that performs setting to permit the reception of the coin-like metal pieces, is operated; collecting characteristics of the coin-like metal pieces thus detected; performing settings so that the coin-like metal pieces can be received in cases where the characteristics of the coin-like metal pieces thus collected do not overlap the characteristics of the receivable coins and variations in the characteristics of the coin-like metal pieces thus collected are within specified values; and generating a predetermined deposit signal when coin-like metal piece that is set as receivable is received.

In addition, the invention of claim 12 is the method of controlling a coin metal processing device according to claim 11, wherein the metal setting means is provided in correspondence with the type of the receivable coin and generates a deposit signal for a type that corresponds with the operated metal setting means when the coin-like metal that is set as receivable is received.

Further, the invention of claim 13 is the method of controlling a coin metal processing device according to claim 11, characterized by comprising the steps of: storing and holding value information on at least one inserted coin; and generating a deposit signal that corresponds with the value information that is stored and held when the coin-like metal that is set as receivable is received.

Furthermore, the invention of claim 14 is the method of controlling a coin metal processing device according to claim 13, wherein the metal setting means is operated after a coin of a predetermined value is inserted and generates a deposit signal that corresponds with value information on the coin of the predetermined value inserted before the metal setting means is operated when the coin-like metal that is set as receivable is received.

In addition, the invention of claim 15 is the method of controlling a coin metal processing device according to claim 13, wherein the metal setting means is operated before a coin of a predetermined value is inserted and generates a deposit signal that corresponds with value information on the coin of the predetermined value inserted after the metal setting means is operated when the coin-like metal that is set as receivable is received.

Further, the invention of claim 16 is the method of controlling a coin metal processing device according to claim 13, characterized by comprising the step of performing setting to permit the reception of one coin-like metal piece at the time of one sales operation.

Furthermore, the invention of claim 17 is the method of controlling a coin metal processing device according to claim 13, characterized by comprising the step of performing setting to permit the reception of a plurality of coin-like metal pieces at the time of one sales operation.

Further, the invention of claim 18 is the method of controlling a coin metal processing device according to claim 11, characterized by comprising the step of canceling the set state where coin-like metal can be received upon detecting the fact that a return lever has been operated for a predetermined time within a predetermined time after the metal setting means is operated.

### EFFECT OF THE INVENTION

The present invention makes it possible to easily set whether the reception of metal-coins is acceptable or unacceptable, and value information and so forth for the metal-coins, to be capable of using both ordinary coins and metal-coins, and to allow both ordinary coins and metal-coins to be used.

### BRIEF DESCRIPTION OF THE DRAWINGS

FIG. 1 is a block diagram showing an example of the functional configuration of a coin metal processing device 1 according to a first embodiment of the present invention;

FIG. 2 is a flowchart showing the processing procedure of a first functional operation performed by the coin metal processing device 1 when permission for the reception of optional metal-coins is set;

FIG. 3 is a flowchart showing the processing procedure of a second functional operation performed by the coin metal processing device 1 when permission for the reception of an optional metal-coin is set;

FIG. 4 shows an example of a table 13 for storing information relating to characteristic data, values and reception corresponding with respective types of coins and metal-coin;

FIG. 5 is a flowchart showing the processing procedure for the reception of coins and metal-coins performed by the coin metal processing device 1 in a case where the reception of one metal-coin is granted;

FIG. 6 is a flowchart showing the processing procedure for the reception of coins and metal-coins performed by the coin metal processing device 1 in a case where the reception of a plurality of metal-coins is granted;

FIG. 7 is a block diagram showing an example of the functional configuration of the coin metal processing device 1 according to a second embodiment of the present invention;

FIG. 8 is a flowchart showing the processing procedure performed by the coin metal processing device when permission for the reception of an optional metal-coin is set, the reception of an optional coin is prohibited, and the value of the coin is set as the set value of the metal-coin; and

FIG. 9 shows an example of the table 13 for storing information relating to characteristic data, value and reception corresponding with respective types of coins and metal-coin.

### EXPLANATION OF REFERENCE NUMERALS

1 coin metal processing device
2 control portion
3 sensor
4 identifying portion
5 setting portion
6 characteristic data collecting portion
7 characteristic data storing portion
8 characteristic data analyzing portion
9 memory
10 sorting portion
11 control portion 11 of automatic vending machine
12 coin
13 table
51 10-yen setting switch
52 50-yen setting switch
53 100-yen setting switch
54 500-yen setting switch

### BEST MODE FOR CARRYING OUT THE INVENTION

Embodiments of the coin metal processing device and method for controlling the device according to the present invention will be described in detail hereinbelow with reference to the attached drawings. A configuration in which the coin metal processing device of the present invention is incorporated into an automatic vending machine will be described as the embodiments.

A first embodiment of the coin metal processing device of the present invention will now be described.

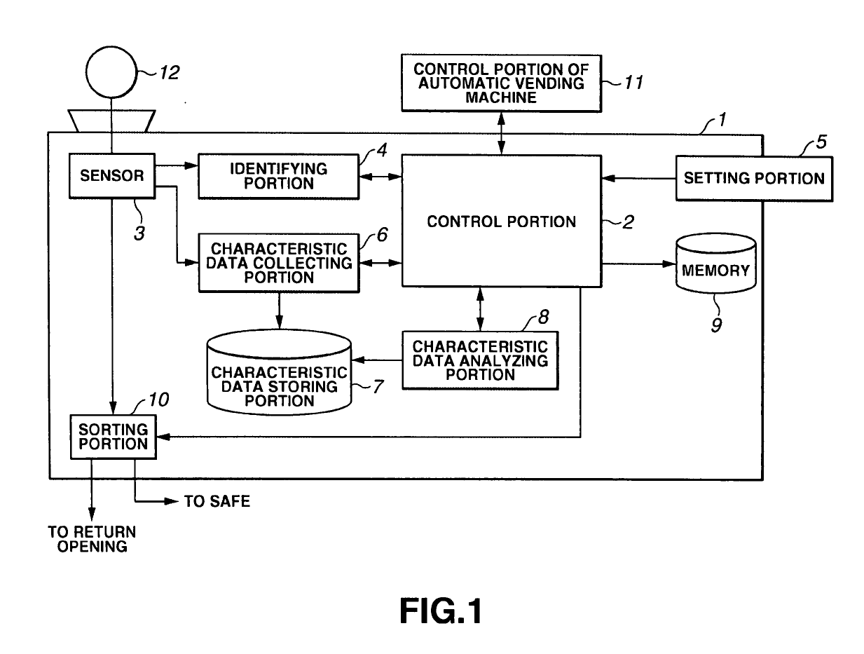

FIG. 1 is a block diagram showing an example of the functional configuration of a coin metal processing device 1 according to the first embodiment of the present invention.

As shown in FIG. 1, the coin metal processing device 1 is constituted by a control portion 2, sensor 3, identifying portion 4, setting portion 5, characteristic data collecting portion 6, characteristic data storing portion 7, characteristic data analyzing portion 8, memory 9, and sorting portion 10.

The control portion 2 controls the whole of the coin metal processing device 1 and performs mutual communications with the control portion 11 of the automatic vending machine.

The sensor 3 is constituted by an oscillation coil that is driven at a predetermined frequency by means of a drive signal from the control portion 2 and a reception coil that is connected electrically to the oscillation coil. The sensor 3 outputs an electrical signal produced by the reception coil to the identifying portion 4 or the characteristic data collecting portion 6 when a coin 12 passes the sensor 3.

The identifying portion 4 acquires characteristic data (coin material, outside diameter, thickness, and so forth, for example) for the coin 12 on the basis of the electrical signal inputted from the sensor 3 and selects whether coin 12 is a ordinary coin (10-yen coin, 50-yen coin, 100-yen coin, and 500-yen coin) or coin-like metal (known as ‘metal-coin’ hereinafter) on the basis of the acquired characteristic data, outputs a signal indicating that coin 12 is a metal-coin to the control portion 2 when metal-coin is selected, identifies the type of the coin from characteristic data when coin is selected, and outputs a signal indicating the identified type of coin to the control portion 2.

The setting portion 5 shifts the coin metal processing device 1 to a metal-coin setting mode or cancels the state where the reception of metal-coins is allowed. The metal-coin setting mode is a mode that allows the reception of metal-coins and therefore causes the coin metal processing device 1 to collect characteristic data of metal-coins and to set a set value for metal-coins and a mode that normally uses the coin metal processing device 1 will subsequently be called the ‘normal mode’.

The setting portion 5 corresponds to metal setting means and a configuration having a metal setting switch that produces a signal for a shift to the metal-coin setting mode may be applied or the configuration may be one in which the metal setting switch is a dedicated switch (including a touch panel or the like) for a shift to the metal-coin setting mode or a configuration in which an existing switch such as a coin reception system switching switch is also used for this mode shift. Further, the setting portion 5 can also be applied in a configuration that receives an external signal from a remote control or automatic vending machine or the like and causes a shift to the metal-coin setting mode.

The characteristic data collecting portion 6 acquires characteristic data of a coin 12 on the basis of an electrical signal that is inputted by the sensor 3 when the coin metal processing device 1 is made to shift to the metal-coin setting mode and stores the acquired characteristic data in the characteristic data storing portion 7. In order to permit reception of metal-coins, characteristic data of a predetermined number of metal-coins must be analyzed and therefore characteristic data of a predetermined number of metal-coins are stored in the characteristic data storing portion 7.

The characteristic data storing portion 7 stores characteristic data of a predetermined number of metal-coins.

The characteristic data analyzing portion 8 analyzes whether the characteristic data of a predetermined number of metal-coins stored in the characteristic data storing portion 7 overlap the respective coin characteristic data and analyzes whether variations in the characteristic data of the predetermined number of metal-coins lie within specified values, and outputs the analysis results to the control portion 2. Here, the characteristic data of the coins are checked for a plurality of characteristics (thickness, diameter, material and so forth, for example) normally for one type and, in the absence of a single overlapping characteristic, it is analyzed that the characteristic data do not overlap.

The memory 9 stores characteristic data corresponding with respective types of coins and metal-coin, values, and reception-related information as a table.

The sorting portion 10 is constituted by a sorting lever that sorts coins 12 and a sorting solenoid that drives the sorting lever. The sorting portion 10 sorts coins judged to be authentic coins or metal-coins whose reception is prohibited to a return opening and sorts coins that are judged as specie or acceptable metal-coins into a safe, and also sorts types for the coins.

Next, a first functional operation that is performed by the coin metal processing device 1 when permission for the reception of metal-coins is set will be described with reference to FIG. 1.

A user of the coin metal processing device 1 inserts coins corresponding to a set value into the coin metal processing device 1 in order to set the set value for the metal-coins, and the inserted coins pass the sensor 3 before being sorted by the sorting portion 10.

When a coin passes the sensor 3, the sensor 3 outputs an electrical signal that is produced by the reception coil to the identifying portion 4 and, when the identifying portion 4 receives the input of the electrical signal, the coin characteristic data are acquired on the basis of the inputted electrical signal, the authenticity of the coin is identified on the basis of the acquired characteristic data, the type of the coin is identified when the coin is identified as being a specie, a signal indicating the identified type is outputted to the control portion 2 and, when the control portion 2 receives the input of the signal indicating the type, the value calculated on the basis of signal indicating the type is stored in the memory 9.

When permission for the reception of an optional metal-coin is set, the user operates the setting portion 5 to shift the coin metal processing device 1 to the metal-coin setting mode and inserts a metal-coin in the coin metal processing device 1 and, when the metal-coin thus inserted passes the sensor 3, the coin is returned by the sorting portion 10.

When the metal-coin passes the sensor 3, the sensor 3 outputs an electrical signal produced by the reception coil to the characteristic data collecting portion 6 and, upon receipt of the input of the electrical signal, the characteristic data collecting portion 6 acquires characteristic data of the metal-coin on the basis of the inputted electrical signal and stores the acquired characteristic data in the characteristic data storing portion 7.

Then, the user inserts a predetermined number of metal-coins into the coin metal processing device 1, whereupon the characteristic data collecting portion 6 collects characteristic data of the predetermined number of metal-coins at any time and stores the data in the characteristic data storing portion 7. The characteristic data analyzing portion 8 reads the characteristic data of the predetermined number of metal-coins from the characteristic data storing portion 7 and analyzes whether the characteristic data of the predetermined number of metal-coins thus read overlap the characteristic data of each coin and analyzes whether variations in the characteristic data of the predetermined number of metal-coins lie within specified values. The characteristic data analyzing portion 8 outputs the analysis results to the control portion 2 and, when the control portion 2 inputs the analysis results, sets the reception of the metal-coins on the basis of the analysis result.

In the case of an analysis result that the characteristic data of the metal-coins do not overlap the characteristic data of the respective coins and variations are within specified values, reception of metal-coins is granted and the value stored in the memory 9 is set as the set value for the metal-coin. Further, in the case of an analysis result that the characteristic data of the metal-coins overlap the characteristic data of each coin or variations lie outside the specified values, reception of the metal-coins is not permitted.

Thereafter, when the setting of permission for the reception of metal-coins is complete, the user operates the setting portion 5 to shift the coin metal processing device 1 from the metal-coin setting mode to the normal mode, whereupon the coin metal processing device 1 is able to receive coins and metal-coins.

In the foregoing, the first functional operation that is performed by a coin metal processing device 1 when setting permission for the reception of metal-coins was described.

Next, a second functional operation that is performed by the coin metal processing device 1 when setting permission for the reception of metal-coins will be described with reference to FIG. 1.

When permission for the reception of optional metal-coins is set, the user of the coin metal processing device 1 operates the setting portion 5 to shift the coin metal processing device 1 to the metal-coin setting mode and inserts metal-coins into the coin metal processing device 1, whereupon the inserted metal-coins pass the sensor 3 and are returned by the sorting portion 10.

When the metal-coins pass the sensor 3, the sensor 3 outputs an electrical signal that is produced by the reception coil to the characteristic data collecting portion 6 and, upon receiving the input of the electrical signal, the characteristic data collecting portion 6 acquires characteristic data of the metal-coins on the basis of the inputted electrical signal and stores the acquired characteristic data in the characteristic data storing portion 7.

Then, the user inserts a predetermined number of metal-coins into the coin metal processing device 1, whereupon the characteristic data collecting portion 6 collects characteristic data of the predetermined number of metal-coins at any time and stores the data in the characteristic data storing portion 7. The characteristic data analyzing portion 8 reads the characteristic data of the predetermined number of metal-coins from the characteristic data storing portion 7 and analyzes whether the characteristic data of the predetermined number of metal-coins thus read overlap the characteristic data of each coin and analyzes whether variations in the characteristic data of the predetermined number of metal-coins lie within specified values. The characteristic data analyzing portion 8 outputs the analysis results to the control portion 2.

In the case of an analysis result that the characteristic data of the metal-coins does not overlap the characteristic data of each coin and variations are within specified values, the user inserts coins corresponding with a set value into the coin metal processing device 1 in order to set the set value of the metal-coins, whereupon the inserted coins pass the sensor 3 and are sorted by the sorting portion 10.

When a coin passes the sensor 3, the sensor 3 outputs an electrical signal that is produced by a reception coil to the identifying portion 4 and, upon receiving the input of the electrical signal, the identifying portion 4 acquires characteristic data of the coin on the basis of the inputted electrical signal, identifies the authenticity of the coin on the basis of the acquired characteristic data, identifies the type of the coin when the coin is identified as specie, outputs a signal indicating the identified type to the control portion 2. Upon receiving the input of the signal indicating the type, the control portion 2 stores the value calculated on the basis of signal indicating the type in the memory 9.

When the user has finished inserting coins corresponding with the set value, the user operates the setting portion 5 to output a notice regarding the end of the operation to the control portion 2 and, upon receiving the input of the notice regarding the end of the operation, the control portion 2 permits reception of metal-coins and sets the value stored in the memory 9 as the set value of the metal-coins.

In the case of an analysis result that the characteristic data of the metal-coins overlap the characteristic data of each coin or variations are outside specified values, the control portion 2 does not permit reception of metal-coins.

Thereafter, when the setting of permission for the reception of metal-coins is complete, the user operates the setting portion 5 to shift the coin metal processing device 1 from the metal-coin setting mode to the normal mode, whereupon the coin metal processing device 1 is able to receive coins and metal-coins.

A configuration in which the coin metal processing device 1 is not shifted to the metal-coin setting mode even when the setting portion 5 is operated in a state where coins are deposited can also be applied.

Further, a configuration in which the coin metal processing device 1 is not shifted from the metal-coin setting mode to the normal mode when there has been no insertion of metal or coins in a predetermined period can also be applied.

In the foregoing, the second functional operation that is performed by the coin metal processing device 1 when permission for the reception of metal-coins is set was described.

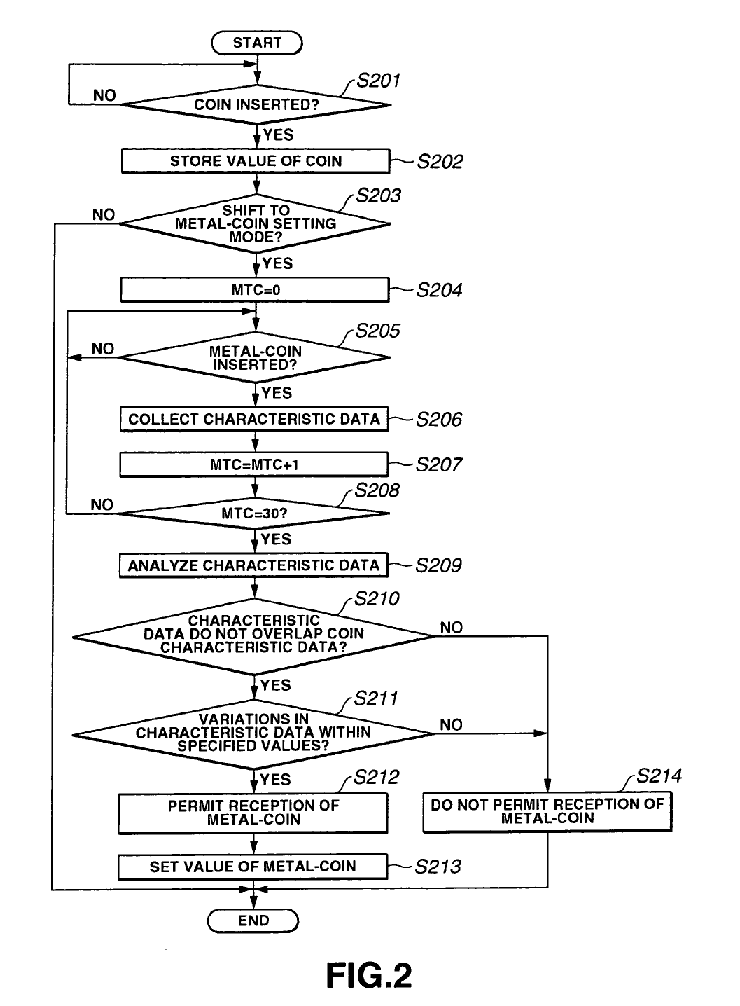

The processing procedure for the first functional operation that is performed by the coin metal processing device 1 when permission for the reception of optional metal-coins are set will be described next with reference to the flowchart shown in FIG. 2.

When coins are inserted into the coin metal processing device (YES in step S201), the types of the coins are identified and the values corresponding with the identified types are stored (step S202). When the coin metal processing device shifts to the metal-coin setting mode (YES in step S203), the setting portion sets ‘MTC (metal-coin counter)=0’ (step S204). When metal-coins are inserted (YES in step S205), characteristic data of the metal-coins are collected (step S206), ‘MTC=MTC+1’ is set (step S207) and, unless ‘MTC=30’ (NO in step S208), the processing returns to step S205. When ‘MTC=30’ (YES in step S208), the characteristic data of thirty metal-coins are analyzed (step S209) and, when the thirty characteristic data do not overlap the characteristic data of each coin (YES in step S210) and when variations in the thirty characteristic data lie within specified values (YES in step S211), the reception of metal-coins is permitted (step S212) and the set value of the metal-coins is set as the value stored in S204 (step S213), whereupon the processing procedure is ended.

In step S210, when the thirty characteristic data overlap the characteristic data of each coin (NO in step S210), the processing procedure is ended without permitting the reception of metal-coins (step 214).

In step S211, when variations in the thirty characteristic data are outside the specified values (NO in step S211), the processing procedure is ended without reception of the metal-coins being permitted (step 214).

In the flowchart shown in FIG. 2, a configuration that collects characteristic data of thirty metal-coins is used as an example. However, the number of collected characteristic data is not limited to thirty. The number of collected characteristic data can be determined arbitrarily.

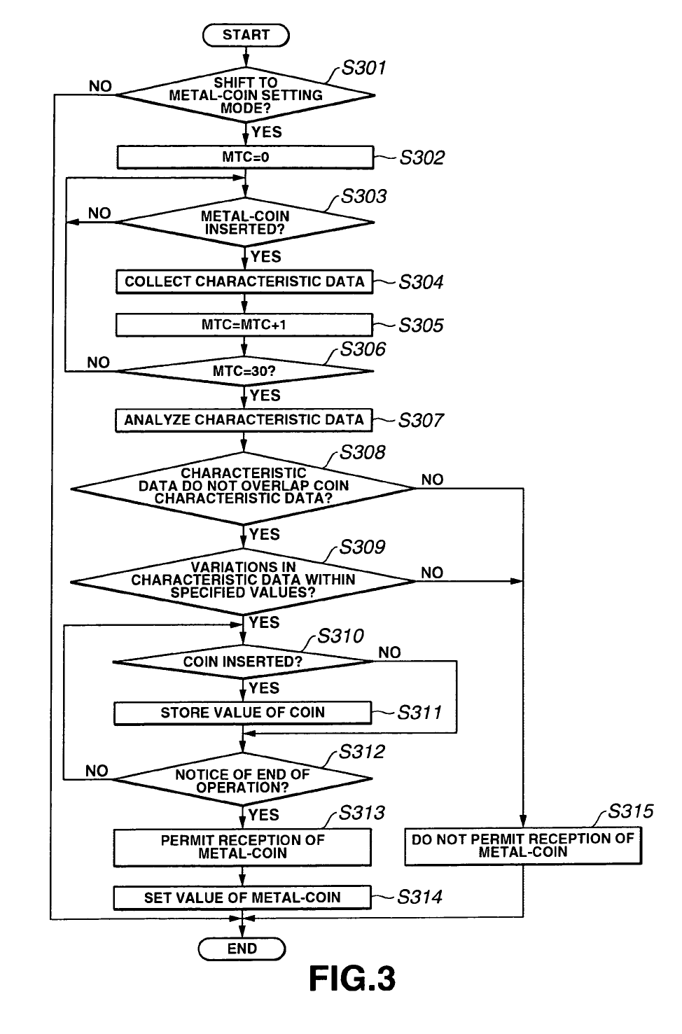

The processing procedure of the second functional operation performed by the coin metal processing device 1 when permission for the reception of optional metal-coins are set will be described next with reference to the flowchart shown in FIG. 3.

When the coin metal processing device shifts to the metal-coin setting mode (YES in step S301), the setting portion sets ‘MTC (metal-coin counter)=0’ (step S302). When metal-coins are inserted (YES in step S303), characteristic data of the metal-coins are collected (step S304), ‘MTC=MTC+1’ is set (step S305) and, unless ‘MTC=30’ (NO in step S306), the processing returns to step S303. When ‘MTC=30’ (YES in step S306), the characteristic data of thirty metal-coins are analyzed (step S307) and, in cases where the thirty characteristic data do not overlap the characteristic data of each coin (YES in step S308) and where variations in the thirty characteristic data lie within specified values (YES in step S309), when coins are inserted (YES in step S310), the types of the coins are identified and the values corresponding with the identified types are stored (step S311). When there is an operation completion notice (step S312), the reception of metal-coins is permitted (step S313) and the set value of the metal-coins is set as the value stored in S311 (step S314), whereupon the processing procedure is ended.

In step S308, when thirty characteristic data overlap the characteristic of each coin (NO in step S308), the processing procedure is ended without permitting the reception of metal-coins (step 315).

In step S309, when variations in thirty characteristic data lie outside the specified values (NO in step S309), the processing procedure is ended without permitting the reception of metal-coins (step 315).

The flowchart shown in FIG. 3 cites a configuration that collects characteristic data of thirty metal-coins as an example. However, the number of collected characteristic data is not limited to thirty. The number of collected characteristic data can be determined arbitrarily.

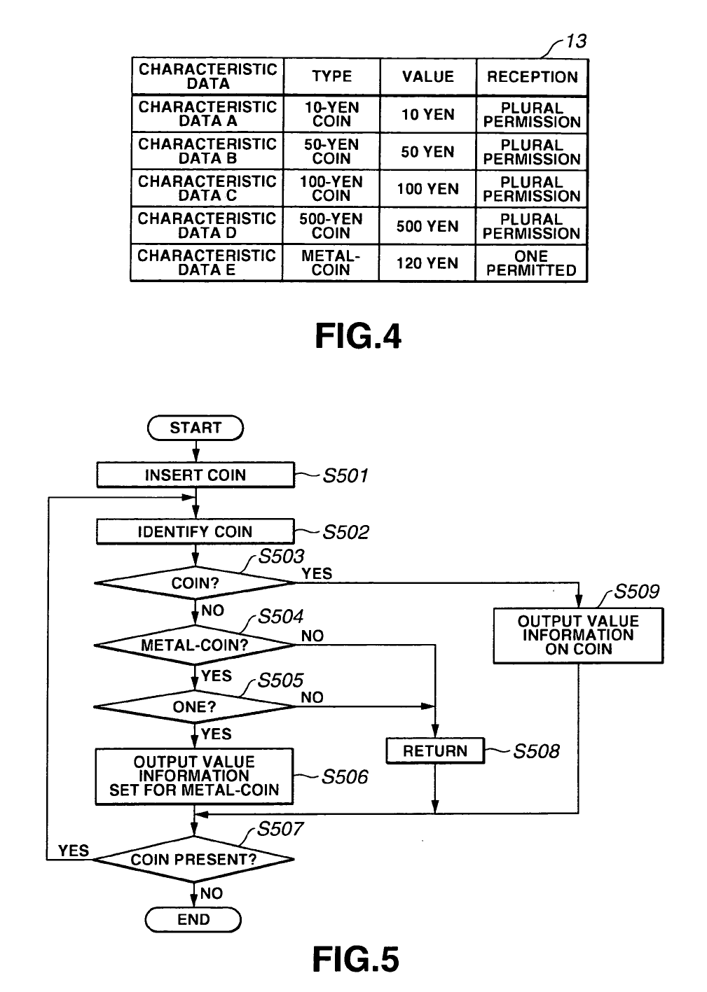

FIG. 4 shows an example of a table 13 for storing information relating to characteristic data, values and reception corresponding with respective types of coins and metal-coin.

As shown in FIG. 4, table 13 stores the fact that, when ‘characteristic data A’ is acquired, it is identified that the inserted coin is a 10-yen coin, and the control portion 2 transmits the value information indicating ‘10 yen’ to the control portion 11 of the automatic vending machine and permits the reception of a plurality of ‘10-yen coins’. The same is also true for ‘50-yen coins’, ‘100-yen coins’, and ‘500-yen coins’.

Further, the fact is stored that, when ‘characteristic data E’ is acquired, it is identified that the inserted coin is a ‘metal-coin’, and the control portion 2 transmits value information indicating ‘120 yen’ to the control portion 11 of the automatic vending machine and permits the reception of one ‘metal-coin’. Although the table shown in FIG. 3 limits the number of inserted ‘metal-coins’ to one, settings for ‘arbitrary number permitted’ or ‘plurality permitted’ are also possible.

A processing procedure for the reception of coins and metal-coins that is performed by the coin metal processing device 1 in a case where the reception of one metal-coin is permitted will be described next with reference to the flowchart shown in FIG. 5.

When a coin is inserted into the coin metal processing device (step S501), the coin is identified (step S502). If the coin is identified as not being a currency coin (NO in step S503), it is identified whether the coin is a metal-coin (step S504).

When the coin is identified as a metal-coin (YES in step S504), it is first confirmed that metal-coins have been inserted (step S505).

When it is confirmed that there is one metal-coin (YES in step S505), value information set for the metal-coin is outputted (step S506) and, when coins remain (YES in step S507), the processing returns to step S502. When no coins remain (NO in step S507), the processing procedure is ended.

In step S504, when it is identified that the coin is not a metal-coin (NO in step S504), or, in step S505, when it is confirmed that there is not one metal-coin (NO in step S505), the metal-coins are returned (step S508) and the processing procedure is ended.

In step S503, when a coin is identified as a coin (YES in step S503), type information on the coin is outputted (step S509) and the processing procedure is ended.

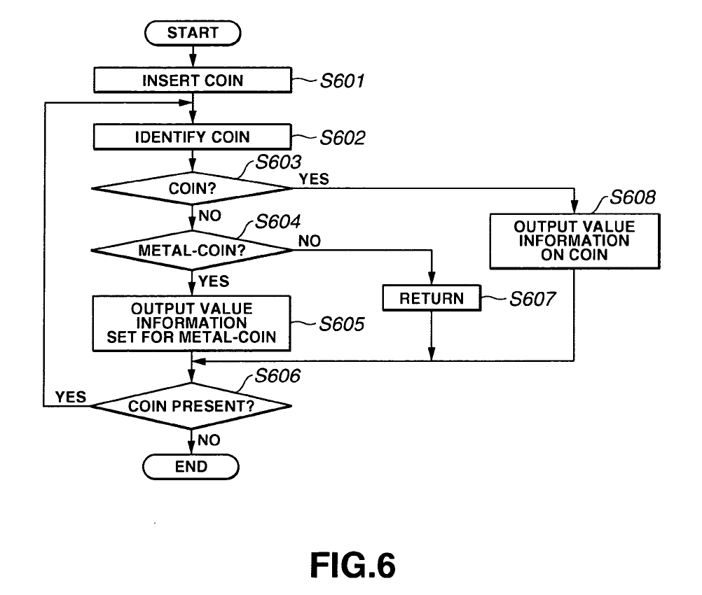

A processing procedure for the reception of coins and metal-coins that is performed by the coin metal processing device 1 in a case where the reception of a plurality of metal-coins is permitted will be described next with reference to the flowchart shown in FIG. 6.

When coins are inserted in the coin metal processing device (step S601), the coins are identified (step S602) and, when no currency coin is identified (NO in step S603), it is identified whether the coin is a metal-coin (step S604).

When a metal-coin is identified (YES in step S604), value information set for the metal-coin is outputted (step S605) and, when coins remain (YES in step S606), the processing returns to step S602. When no coins remain (NO in step S606), the processing procedure is ended.

In step S604, when it is identified that there are no metal-coins (NO in step S604), metal-coins are returned (step S607) and the processing procedure is ended.

In step S603, when a coin is identified (YES in step S603), value information on the coin is outputted (step S608) and the processing procedure is ended.

The first embodiment of the coin metal processing device according to the present invention was described hereinabove. A second embodiment of the coin metal processing device according to the present invention will be described next.

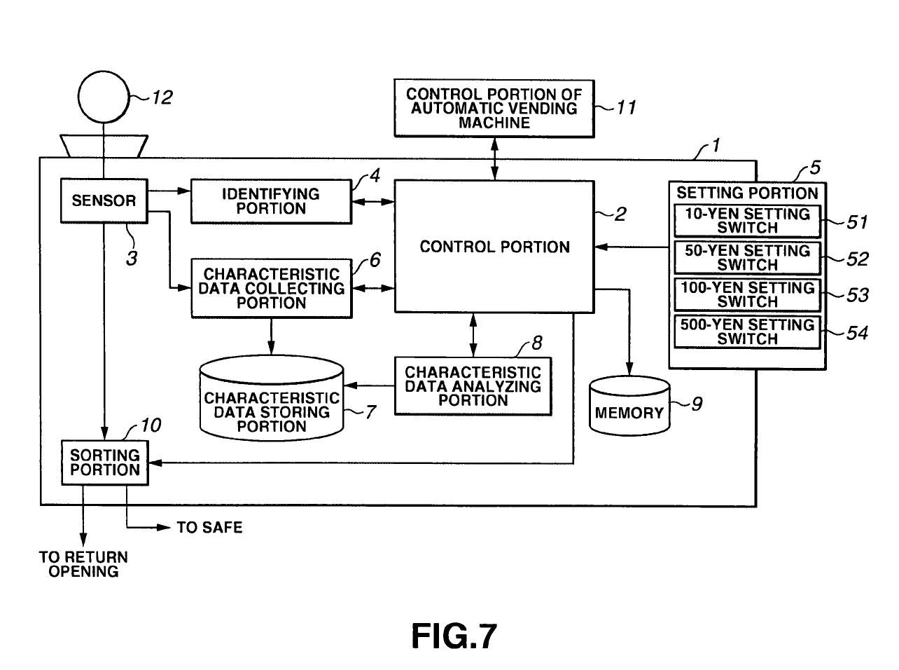

FIG. 7 is a block diagram showing an example of the functional configuration of the coin metal processing device 1 according to the second embodiment of the present invention.

As shown in FIG. 7, the functional configuration of the coin metal processing device 1 of the second embodiment is the same as that of the coin metal processing device 1 in the first embodiment. However, the coin metal processing device 1 in the second embodiment has a configuration in which a function for shifting the coin metal processing device 1 to the metal-coin setting mode is added to a setting switch that is provided in a conventional coin metal processing device and whose object it is to set the identification accuracy for each coin, for example.

Therefore, the setting portion 5 is constituted by a 10-yen setting switch 51, 50-yen setting switch 52, 100-yen setting switch 53, and 500-yen setting switch 54. For example, the 10-yen setting switch 51 sets the accuracy of identification that is performed by the identifying portion 4 when a 10-yen coin is identified, there also being switches that are capable of setting a plurality of identification accuracies as per the ‘normal’, ‘accuracy 1’, and ‘accuracy 2’. Further, the same is also true of the 50-yen setting switch 52, 100-yen setting switch 53, and 500-yen setting switch 54. Further, the setting switches are not limited to switches that set the identification accuracy. Switches that are capable of performing a variety of settings can also be applied.

The configuration of the coin metal processing device 1 in the second embodiment is such that, when an arbitrary setting switch is operated to set the identification accuracy at accuracy 2, the reception of coins with respective to the setting switch is prohibited by shifting the coin metal processing device 1 to the metal-coin setting mode and the value of the coins is set as the set value of the metal-coins. For example, the configuration is such that, when the identification accuracy is set at accuracy 2 by operating the 10-yen setting switch 51, the reception of 10-yen coins is prohibited by shifting the coin metal processing device 1 to metal-coin setting mode and the set values of the inserted metal-coins is set at 10 yen.

A functional operation that is performed by the coin metal processing device 1 when setting permission for the reception of metal-coins will be described next with reference to FIG. 7.

In cases where the reception of optional metal-coins is permitted, the reception of optional coins is prohibited, and the value of prohibited coins is set as the set value of the metal-coins, when the user of the coin metal processing device 1 operates the setting switch corresponding with the coins whose reception is prohibited in order to set the identification accuracy as accuracy 2, the coin metal processing device 1 is shifted to the metal-coin setting mode.

Further, the user inserts metal-coins into the coin metal processing device 1 and the inserted metal-coins pass the sensor 3 and are returned by the sorting portion 10.

When the sensor 3 outputs an electrical signal that is produced by the reception coil to the characteristic data collecting portion 6 in the event that a metal-coin passes the sensor 3 and the characteristic data collecting portion 6 inputs the electrical signal, characteristic data of the metal-coin is acquired on the basis of the inputted electrical signal and the acquired characteristic data is stored in the characteristic data storing portion 7.

The user then inserts a predetermined number of metal-coins into the coin metal processing device 1.

The characteristic data collecting portion 6 collects the characteristic data of a predetermined number of metal-coins at any time and stores the characteristic data in the characteristic data storing portion 7. The characteristic data analyzing portion 8 reads the characteristic data of a predetermined number of metal-coins from the characteristic data storing portion 7 and analyzes whether the characteristic data of the predetermined number of metal-coins thus read overlaps the characteristic data of each type of coin (10-yen coin, 50-yen coin, 100-yen coin, and 500-yen coin) and analyzes whether variations in the characteristic data of the predetermined number of metal-coins lie within specified values. The characteristic data analyzing portion 8 then outputs the analysis results to the control portion 2.

Further, upon receiving the input of the analysis results, the control portion 2 sets the reception of the metal-coins on the basis of the analysis results. Here, in the case of an analysis result that the characteristic data of the metal-coins do not overlap the characteristic data of the respective coins and variations are within specified values, reception of metal-coins is granted and the value stored in memory is set as the set value for the metal-coins. Further, in the case of an analysis result that the characteristic data of the metal-coins overlap the characteristic data of each type of coin or variations lie outside the specified values, reception of the metal-coins is not permitted.

Thereafter, when the setting of permission for the reception of metal-coins is complete, the user operates the setting switch to set the identification accuracy as normal, whereby the coin metal processing device 1 is shifted from the metal-coin setting mode to the normal mode and the coin metal processing device 1 is able to receive coins and metal-coins.

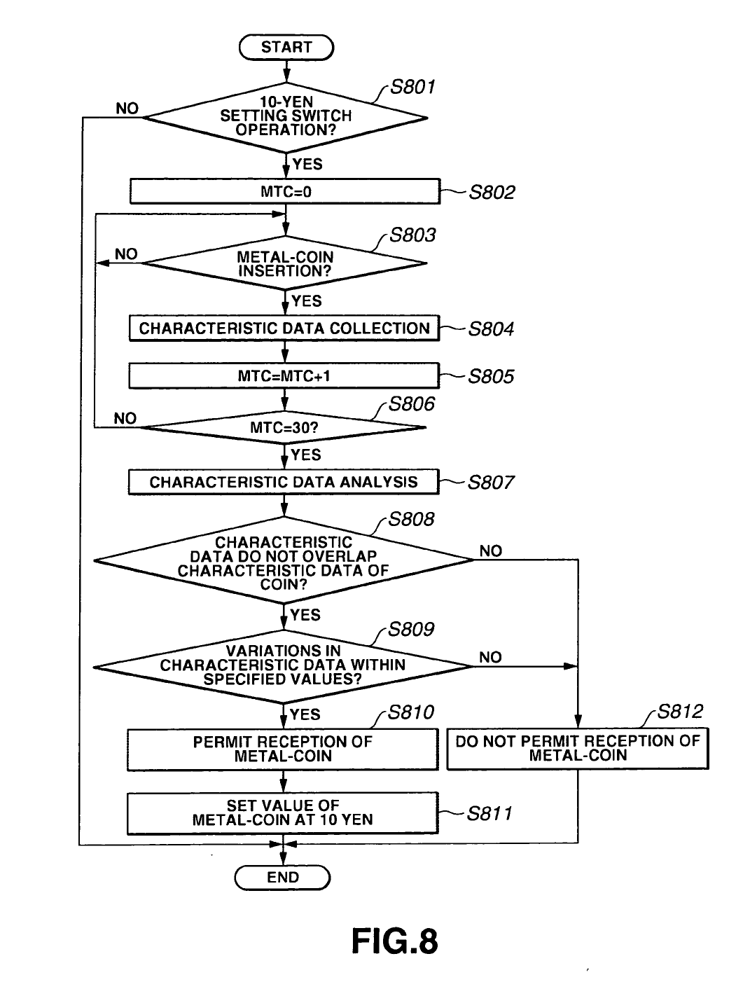

A processing procedure that is performed by a coin metal processing device when permission for the reception of optional metal-coins is set, the reception of optional coins is prohibited, and the value of the coins is set as the set value of the metal-coins, will be described next with reference to the flowchart shown in FIG. 8. Further, a case where the coin metal processing device 1 is shifted to the metal-coin setting mode by operating the 10-yen setting switch 51 will be described by way of specific example.

When the coin metal processing device is shifted to the metal-coin setting mode by the 10-yen setting switch (YES in step S801), ‘MTC (metal-coin counter)=0’ is set (step S802) and, when metal-coins are inserted (YES in step S803) characteristic data of the metal-coins are collected (step S804), ‘MTC=MTC+1’ is set (step S805). When ‘MTC=30’ is not true (NO in step S806), the processing returns to step S803. When ‘MTC=30’ is true (YES in step S806), characteristic data of thirty metal-coins are analyzed (step S807) and, when the thirty characteristic data do not overlap the characteristic data of each coin (YES in step S808) and when variations in the thirty characteristic data lie within specified values (YES in step S809), the reception of the metal-coins is permitted (step S810) and the set value of the metal-coins is set as 10 yen (step S811), whereupon the processing procedure is ended.

Further, in step S808, when the thirty characteristic data overlap the characteristic data of each coin (NO in step S808), the processing procedure is ended without permitting the reception of metal-coins (step 812).

Furthermore, in step S809, when variations in the thirty characteristic data lie outside the specified values (NO in step S809), the processing procedure is ended without permitting the reception of metal-coins (step 812).

Further, the number of collected characteristic data is limited to thirty as is the case in the first embodiment.

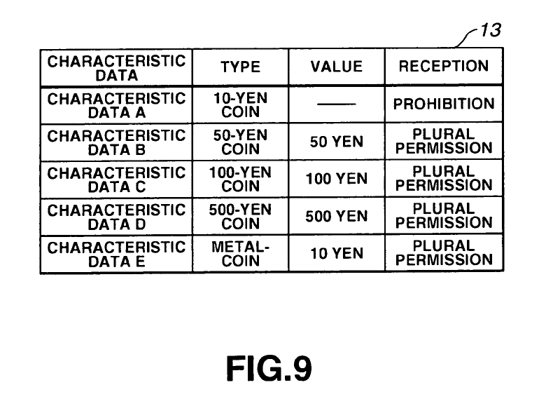

FIG. 9 shows an example of the table 13 for storing information relating to characteristic data, value and reception corresponding with respective types of coins and metal-coin.

As shown in FIG. 9, table 13 stores the fact that, when ‘characteristic data A’ is acquired, it is identified that the inserted coin is a 10-yen coin, the reception of the ‘10-yen coin’ is prohibited and, therefore, the control portion 2 does not transmit value information to the control portion 11 of the automatic vending machine. Further, table 13 stores the fact that, when the ‘characteristic data B’ is acquired, it is identified that the inserted coin is a ‘50-yen coin’, the control portion 2 transmits value information indicating ‘50 yen’ to the control portion 11 of the automatic vending machine and permits reception of a plurality of ‘50-yen coins’. Further, the same is also true for ‘100-yen coins’ and ‘500-yen coins’.

Further, table 13 stores the fact that, when ‘characteristic data E’ is acquired, it is identified that the inserted coin is a ‘metal-coin’, the control portion 2 transmits value information indicating ‘10-yen’ to the control portion 11 of the automatic vending machine and permits reception of a plurality of ‘metal-coins’. Further, the number of received ‘metal-coins’ is not limited to a plurality as is the case in the first embodiment.

A configuration in which the reception of coins corresponding with the setting switch is prohibited by shifting the coin metal processing device 1 to the metal-coin setting mode by operating an arbitrary setting switch is applied in the above embodiment. However, a configuration in which coins are inserted and the reception of the inserted coins is prohibited after the shift to the metal-coin setting mode as per Example 1, for example, instead of prohibiting the reception of coins corresponding with the setting switch even when the coin metal processing device 1 has been shifted to the metal-coin setting mode by operating the arbitrary setting switch, may be applied.

Further, as an operation for canceling permission for reception of the metal-coins, a configuration in which permission for the reception of metal-coins is canceled by lowering a return lever or the like (not illustrated) a predetermined time or more after operating the setting portion and in which inspection lamps or the like switch on and off a predetermined number of times when permission is canceled is adopted but there is no need to limit the present invention to such a configuration.

The following may be considered as specific application examples in which the coin metal processing device according to the present invention is used.

For example, a first application in which, when a customer who visits a shopping center or the like by car makes purchases corresponding to a predetermined value and the customer has parking fees corresponding to a fixed time paid for, a metal-coin created with the value of the parking fees being paid for is given to the customer, the customer inserts the metal-coin into the parking meter provided with the coin metal processing device according to the present invention when the customer leaves, and pays parking fees by continuing to insert coins if the parking fees are not entirely paid for by the metal-coins.

In addition, a second application in which, when one drink is given to a customer visiting a (promotional) campaign or the like, a metal-coin created with the value for one drink is given to the customer and the customer inserts the metal-coin into an automatic vending machine that is specified by the campaign in order to purchase a drink. Further, in the case of the second application, because automatic vending machines that make conventional sales may be set to permit the reception of metal-coins only during the period of the campaign, if the coin metal processing device according to the present invention is provided, settings to permit the reception of metal-coins immediately before the start of the campaign and settings to prohibit the receipt of the metal-coins immediately after the end of the campaign are straightforward.

Further, a third application in which, when a customer who has purchased a product is provided with points and exchanges the points for a gift or the like when a predetermined number of points have been collected, a metal-coin set with a value corresponding with points is given to the customer when the customer purchases a product and, when the customer has collected a predetermined number of metal-coins, they exchange a gift or the like by inserting the metal-coins in a gift exchange machine or the like.

The coin metal processing device according to the present invention is not limited to or by the above embodiments and application examples that represent a configuration of the coin metal processing device that is used in an automatic vending machine. The coin metal processing device according to the present invention can be applied to a coin metal processing device that is used in a variety of payment machines, exchange machines, and game machines

1. A coin metal processing device which is incorporated in an automatic vending machine and performs desired processing by receiving coins and coin-like metal pieces that are inserted into the coin metal processing device, comprising:
metal setting means for shifting the coin metal processing device to a mode that performs setting to permit reception of the coin-like metal pieces;
characteristic detecting means for detecting respective characteristics of a predetermined number of coin-like metal pieces inserted continuously after the metal setting means is operated;
characteristic collecting means for collecting the characteristics of the coin-like metal pieces detected by the characteristic detecting means;
metal piece reception setting means for performing setting so that the coin-like metal pieces can be received in cases where the characteristics of the coin-like metal pieces collected by the characteristic collecting means do not overlap characteristics of receivable coins and variations in the characteristics of the coin-like metal pieces collected by the characteristic collecting means are within specified values; and
deposit signal generating means for generating a predetermined deposit signal when a coin-like metal piece that is set as receivable by the metal reception setting means is received.

2. The coin metal processing device according to claim 1, wherein the metal setting means is provided in correspondence with type of a receivable coin, and
the deposit signal generating means generates a deposit signal of a type that corresponds with the operated metal setting means.

3. The coin metal processing device according to claim 2, wherein the metal setting means comprises a reception accuracy switching switch that is provided in correspondence with a type of a receivable coin.

4. The coin metal processing device according to claim 1, further comprising value information storing means for storing and holding value information for at least one inserted coin, wherein the deposit signal generating means generates a deposit signal that corresponds with value information stored and held by the value information storing means.

5. The coin metal processing device according to claim 4, wherein the metal setting means is operated after a coin of a predetermined value is inserted, and
the deposit signal generating means generates a deposit signal that corresponds with value information on the coin of the predetermined value inserted before the metal setting means is operated.

6. The coin metal processing device according to claim 4, wherein the metal setting means is operated before a coin of a predetermined value is inserted, and
the deposit signal generating means generates a deposit signal that corresponds with value information on the coin of the predetermined value that is inserted after the metal setting means is operated.

7. The coin metal processing device according to claim 4, wherein the metal reception setting means performs setting to enable the reception of one coin-like metal piece at the time of one sales operation.

8. The coin metal processing device according to claim 4, wherein the metal reception setting means performs settings to enable the reception of a plurality of coin-like metal pieces at the time of one sales operation.

9. The coin metal processing device according to claim 1, further comprising metal reception setting canceling means for canceling the state where coin-like metal can be received, which is set by the metal reception setting means.

10. The coin metal processing device according to claim 9, wherein the metal reception setting canceling means cancels the state where coin-like metal can be received, which is set by the metal reception setting means, upon detecting a fact that a return lever has been operated for a predetermined time within a predetermined time after the metal setting means is operated.

11. A method of controlling a coin metal processing device which is incorporated in an automatic vending machine and performs desired processing by receiving coins and coin-like metal pieces that are inserted into the coin metal processing device, comprising the steps of:
detecting respective characteristics of a predetermined number of coin-like metal pieces that are inserted continuously after metal setting means, which shifts the coin metal processing device to a mode that performs setting to permit the reception of the coin-like metal pieces, is operated;
collecting characteristics of the coin-like metal pieces thus detected;
performing settings so that the coin-like metal pieces can be received in cases where the characteristics of the coin-like metal pieces thus collected do not overlap the characteristics of the receivable coins and variations in the characteristics of the coin-like metal pieces thus collected are within specified values; and
generating a predetermined deposit signal when coin-like metal piece that is set as receivable is received.

12. The method of controlling a coin metal processing device according to claim 11, wherein the metal setting means is provided in correspondence with a type of the receivable coin and generates a deposit signal for the type that corresponds with the operated metal setting means when the coin-like metal piece that is set as receivable is received.

13. The method of controlling a coin metal processing device according to claim 11, further comprising the steps of:
storing and holding value information on at least one inserted coin; and
generating a deposit signal that corresponds with the value information that is stored and held when the coin-like metal piece that is set as receivable is received.

14. The method of controlling a coin metal processing device according to claim 13, wherein the metal setting means is operated after a coin of a predetermined value is inserted, and generates a deposit signal that corresponds with value information on the coin of the predetermined value inserted before the metal setting means is operated when the coin-like metal piece that is set as receivable is received.

15. The method of controlling a coin metal processing device according to claim 13, wherein the metal setting means is operated before a coin of a predetermined value is inserted, and generates a deposit signal that corresponds with value information on the coin of the predetermined value inserted after the metal setting means is operated when the coin-like metal piece that is set as receivable is received.

16. The method of controlling a coin metal processing device according to claim 13, further comprising the step of performing setting to permit the reception of one coin-like metal piece at the time of one sales operation.

17. The method of controlling a coin metal processing device according to claim 13, further comprising the step of performing setting to permit the reception of a plurality of coin-like metal pieces at the time of one sales operation.

18. The method of controlling a coin metal processing device according to claim 11, further comprising the step of canceling the set state where a coin-like metal piece can be received upon detecting a fact that a return lever has been operated for a predetermined time within a predetermined time after the metal setting means is operated.
